(19) United States
(12) Patent Application Publication
(10) Pub. No.: US 2020/0053426 A1
(43) Pub. Date: Feb. 13, 2020

(54) METHOD AND SYSTEM FOR MANAGING CONTENT DISTRIBUTION

(71) Applicant: Viv LLC, The Woodlands, TX (US)

(72) Inventor: Vivian Marie Wise, Houston, TX (US)

(21) Appl. No.: 16/490,429

(22) PCT Filed: Mar. 2, 2018
(86) PCT No.: PCT/US2018/020721

§ 371 Date: Aug. 30, 2019

Related U.S. Application Data
(60) Provisional application No. 62/466,274, filed on Mar. 2, 2017.

(51) Int. Cl. H04N 21/442; H04N 21/2187; H04N 21/478

(52) U.S. Cl. CPC H04N 21/44222; H04N 21/478; H04N 21/2187

(57) ABSTRACT

In general, embodiments of the invention relate to method and system for content distribution. More specifically, one or more embodiments of the invention relate to managing content distribution during live events such that certain content is only made available at specific times during the live event. Other embodiments of the invention enable a live stream (e.g., a live video stream) to be broadcast to client devices and, in addition, other content to be selectively made available to the client devices at certain times during the live event.

### BACKGROUND

There has been an increase in content generation. This has resulted in an increase in the mechanisms for distributing the newly generated content. Traditional mechanism for content distribution have limited functionality to determine how and when various types of content may be concurrently distributed and/or how and when to provide access to the various types of content.

### SUMMARY

In general, embodiments of the invention relate to a method for managing content distribution for an event. The method includes establishing, by the streaming server, a connection with a client device, providing, by the streaming server, streaming content for the event over the connection to the client device, while the streaming server is providing content to the client device: issuing a message from a messaging server to the client device, wherein the message is associated with at least a portion of the content from the streaming server, receiving analytics information from the client device, wherein the analytics information specifies that a user of the client device interacted with one selected from group consisting of message content in the message and content referenced by the message.

In general, embodiments of the invention relate to a method for managing content distribution for an event, comprising: establishing, by the client device, a connection with a streaming server, receiving, by the client device, streaming content for the event over the connection, while the client device is receiving the content: receiving a message from a messaging server, wherein the message comprises message content which corresponds to at least a portion of the streaming content, displaying at least the portion of the message content on the client device, collecting, after the displaying, analytics information from the client device, wherein the analytics information specifies that the user of the client device interacted with content in the message.

In general, embodiments of the invention relate to a method for managing content distribution for an event, comprising: establishing, by the client device, a connection with a streaming server, receiving, by the client device, streaming content for the event over the connection, while the client device is receiving the content: receiving a message from a messaging server, wherein the message comprises a reference to a clothing item record for a clothing item, wherein the clothing item is included in to at least a portion of the streaming content, issuing a request to content management server (CMS) for the clothing item record using the reference, receiving the clothing item record from the CMS, displaying at least the portion of the clothing item record on the client device, collecting, after the displaying, analytics information from the client device, wherein the analytics information specifies that the user of the client device interacted with at least a portion of the clothing item record.

In general, embodiments of the invention relate to a non-transitory computer readable medium comprising computer readable program code, which when executed by a computer processor enables the computer processor to perform a method for servicing requests, the method comprising: establishing, by the streaming server, a connection with a client device, providing, by the streaming server, streaming content for an event over the connection to the client device, while the streaming server is providing content to the client device: issuing a message from a messaging server to the client device, wherein the message is associated with at least a portion of the content from the streaming server, receiving analytics information from the client device, wherein the analytics information specifies that a user of the client device interacted with one selected from group consisting of message content in the message and content referenced by the message.

In general, embodiments of the invention relate to a non-transitory computer readable medium comprising computer readable program code, which when executed by a computer processor enables the computer processor to perform a method for servicing requests, the method comprising: establishing, by the client device, a connection with a streaming server, receiving, by the client device, streaming content for the event over the connection, while the client device is receiving the content: receiving a message from a messaging server, wherein the message comprises message content which corresponds to at least a portion of the streaming content, displaying at least the portion of the message content on the client device, collecting, after the displaying, analytics information from the client device, wherein the analytics information specifies that the user of the client device interacted with content in the message.

In general, embodiments of the invention relate to a non-transitory computer readable medium comprising computer readable program code, which when executed by a computer processor enables the computer processor to perform a method for servicing requests, the method comprising: establishing, by the client device, a connection with a streaming server, receiving, by the client device, streaming content for the event over the connection, while the client device is receiving the content: receiving a message from a messaging server, wherein the message comprises a reference to a clothing item record for a clothing item, wherein the clothing item is included in to at least a portion of the streaming content, issuing a request to content management server (CMS) for the clothing item record using the reference, receiving the clothing item record from the CMS, displaying at least the portion of the clothing item record on the client device, collecting, after the displaying, analytics information from the client device, wherein the analytics information specifies that the user of the client device interacted with at least a portion of the clothing item record.

Other aspects of the invention will be apparent from the following description and the appended claims.

### BRIEF DESCRIPTION OF DRAWINGS

FIG. 1 shows a system in accordance with one or more embodiments of the invention.

FIG. 2.1 shows relationships between various components in accordance with one or more embodiments of the invention.

FIG. 2.2 shows a clothing item record in accordance with one or more embodiments of the invention.

FIG. 2.3 shows a user profile in accordance with one or more embodiments of the invention.

FIGS. 3-5.2 show flowcharts in accordance with one or more embodiments of the invention.

FIG. 6 shows an example user interface for an event application on the client device in accordance with one or more embodiments of the invention.

FIG. 7 shows a computing system in accordance with one or more embodiments of the technology

### DETAILED DESCRIPTION

Specific embodiments of the technology will now be described in detail with reference to the accompanying figures. In the following detailed description of embodiments of the technology, numerous specific details are set forth in order to provide a more thorough understanding of the technology. However, it will be apparent to one of ordinary skill in the art that the technology may be practiced without these specific details. In other instances, well-known features have not been described in detail to avoid unnecessarily complicating the description.

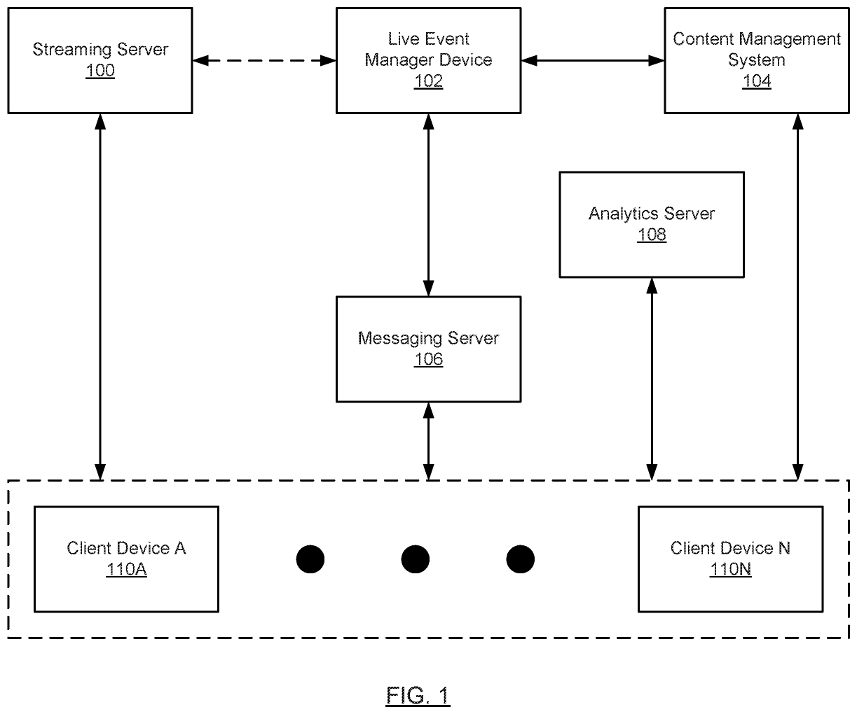

In the following description of FIGS. 1-7, any component described with regard to a figure, in various embodiments of the technology, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the technology, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for content distribution. The content that is distributed may be related to live events. Additionally, or alternatively, the content that is distributed may be related to other content generated from photo shoots and/or scenarios in which content may be generated (e.g., computer generated images, etc.).

More specifically, one or more embodiments of the invention relate to managing content distribution during live events such that certain content is only made available at specific times during the live event. Other embodiments of the invention enable a live stream (e.g., a live video stream) to be broadcast to client devices and, in addition, other content to be selectively made available to the client devices at certain times during the live event.

For example, the live event may be a fashion show. In this example, a live stream of models walking down the runway may be broadcast to client devices. Further, when a specific model walks down the runway wearing a specific piece(s) of clothing (also referred to as a “look”), other content related to the “look” that is currently being shown on the live stream may be transmitted to and/or otherwise made accessible on the client device. Continuing with this example, assume that there are five looks (L1-L5) in the fashion show where each look is associated with a model (M1-M5). In this scenario, a live stream may be broadcast showing model M1 walking down the runway in look L1. As this is occurring (and being broadcast via the live stream), other content associated with look L1 may be transmitted to the client devices. In this example, the other content associated with the look L1 may include information about the look such as pricing, sizes, and colors. However, because models M2-M5 have not yet walked down the runway (i.e., there has been no live stream of looks L2-L5), other content associated with looks L2-L5 is not available. Such other content, in one or more embodiments of the invention, may only become available if the looks are shown on live stream. Accordingly, if the fashion show has planned to debut looks L1-L5 but only looks L1-L4 were shown via the live stream, then only the other content associated with L1-L4 may be shown (or otherwise made available) on the client devices. While the above example focuses on a fashion show and content related to looks at a fashion show, embodiments of the invention are not limited to such scenarios.

In one embodiment of the invention, the look may also include jewelry (or other accessories such as shoes, scarves, etc.). In such cases, the jewelry that the model is wearing in the look may also be added to the lookbook.

In other embodiments of the invention, instead of providing a live stream of the event, still images from the event may be shown instead. For example, during the live event model M1 may be walking down the runway in look L1. In this example, while model M1 is walking down the runway. a photograph (or image) of model M1 in look L1 is shown on the client device.

FIG. 1 shows a system in accordance with one or more embodiments of the invention. The system includes a streaming server (200), a live event manager device (202), a content management system (204), a messaging server (206), an analytics server (208), and one or more client devices (210A, 201N). The aforementioned components may communicate with each other using any known or later discovered communication protocol. Further, the aforementioned components may communicate using any combination of wired and/or wireless connections and wired and/or wireless networks. Each of the aforementioned components is described below.

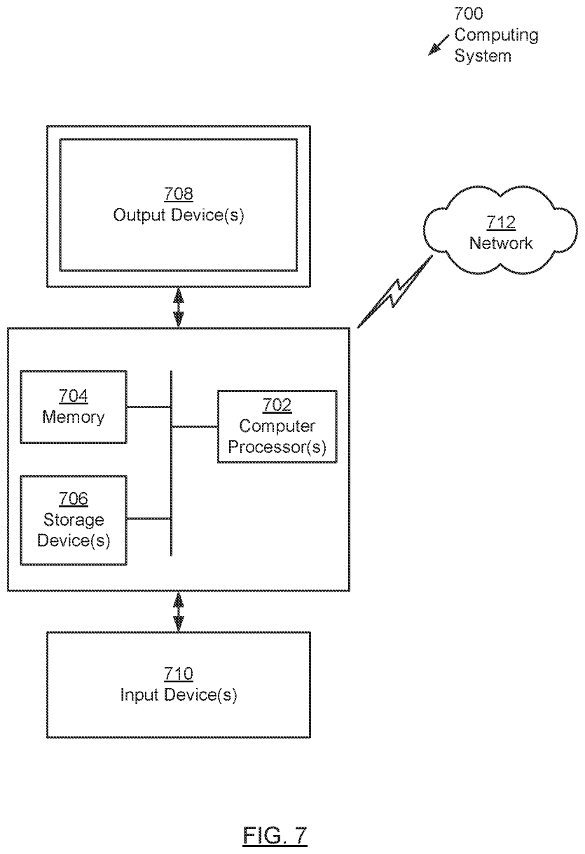

In one embodiment of the invention, a streaming server (200) corresponds to any computing system(s) (see e.g., FIG. 7) that includes functionality to establish a connection with one or more client devices. The streaming server may be implemented using any streaming protocols the currently exist and/or that are later discovered.

In one embodiment of the invention, a live event manager device (202) corresponds to any computing system(s) (see e.g., FIG. 7) that includes functionality to enable a user (e.g., an event manager) to initiate access to certain content at specific times. More specifically, the live event manager device (202) may include functionality: (i) obtain content from the content management system in order to display such content to a user of the live event manager device (202), (ii) display the content (or a portion thereof) via an event management application (not shown) executing on the live event manager device (202); (iii) permit the user of the live event management application to select (or otherwise specify) content to be displayed on the client device (i.e., the client devices that are currently also concurrently viewing the live stream from the streaming server); (iv) generate, in response to the selection of content, an activation notification; and (v) issue the activation notification to a messaging server.

In one embodiment of the invention, the content obtained from the content management server may be displayed as a scrollable list, where each item in the scrollable list includes: (i) the name of content (e.g., the name of the look), the name of model, and/or (iii) an image of look (which may be an image of the model wearing the look). The event management application may also include functionality to modify the order in which the items are displayed on the scrollable list. Those skilled in the art will appreciate that at the invention is not limited to displaying the content on the event management application as a scrollable list.

In one embodiment of the invention, the event management application may include functionality to request confirmation of the selection (i.e., the selection in step (iii)) prior to performing step (iv)). In such instances, a confirmation notice may be visually displayed on the event management application and the user may be required to perform second action (e.g., press a button displayed in the event confirmation notice) to confirm the selection. In one embodiment of the invention, the event management application may support one or more additional security features such as a PIN code, biometrics, etc. In such scenarios, the security features may be used to ensure that the individual using the event management application is an authorized individual. In another embodiment of the invention, there may be multiple event managers for a single event, where each of the event managers uses their own live event manager device. In such instances, all of the live event manager devices may be executing their own instance of the event management application but the content shown in each on each instance may be same or substantially the same. Further, in this scenario, any of the event managers may use their own live event manager device to generate an activation notification.

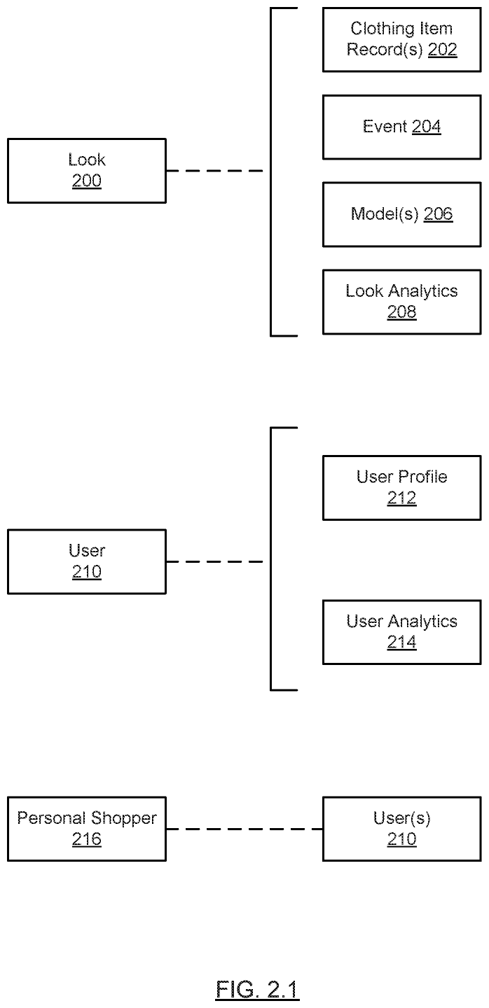

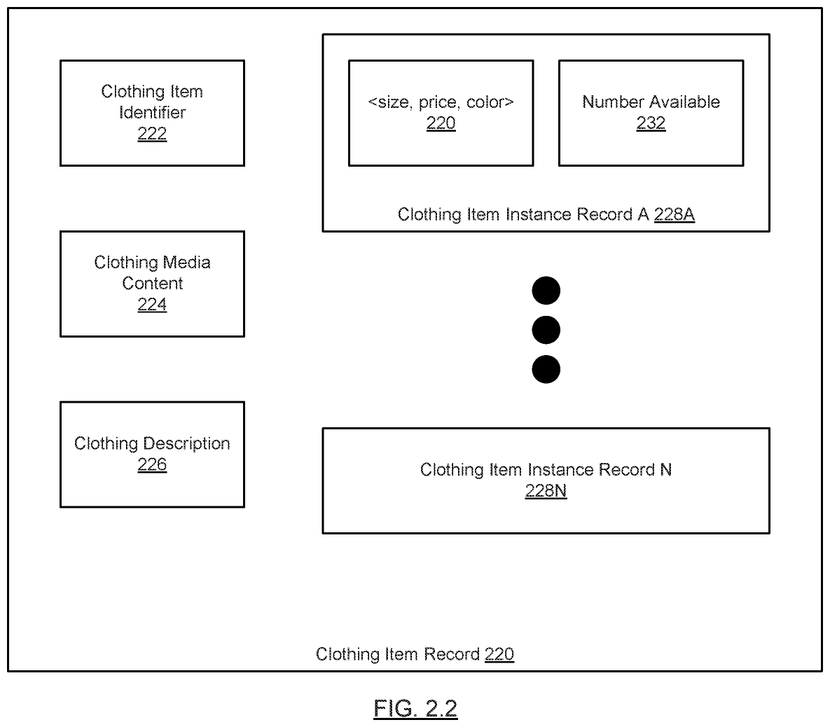

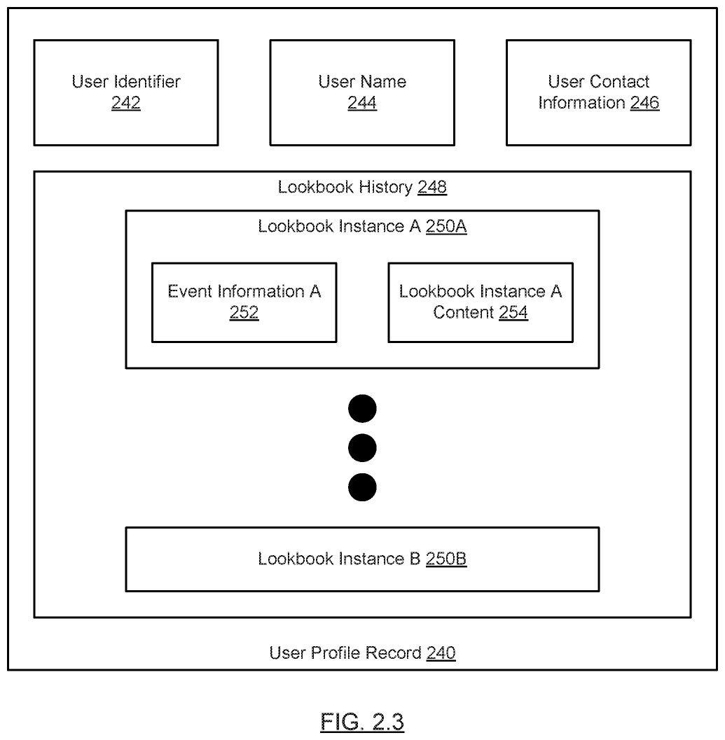

Continuing with the discussion of FIG. 1, in one embodiment of the invention, a content management system (204) corresponds to any computing system(s) (see e.g., FIG. 7) that includes functionality to store clothing item records (see e.g., FIG. 2.2), user profiles (see e.g., FIG. 2.3), and functionality to provide one or more of the aforementioned records to the live event device manager (202), to the messaging server, and/or to the client devices (210A, 201N). In addition content management system (204) may include a secure interface (not shown) which may be used by authorized users to create, populate, and/or modify clothing item records, user profile records, and/or any other records (or data structures) on the content management system.

In one embodiment of the invention, a messaging server (206) corresponds to any computing system(s) (see e.g., FIG. 7) that includes functionality to: (i) enable client devices (210A, 210N) to subscribe to (or otherwise register with) the messaging server in order to receive messages (via a push or pull mechanism) for a particular event; (ii) receive activation notifications from the live event manager device (202); (iii) generate messages, in response to the activation notifications, that include clothing item records (or portions thereof) and/or messages that include references to clothing item records; and (iv) providing (via a push or pull mechanism) the messages to the client devices that are subscribed to the messaging server for the particular event.

In one embodiment of the invention, an analytics server (208) corresponds to any computing system(s) (see e.g., FIG. 7) that includes functionality to: (i) receive analytics information about how users of the client devices are interacting with the content from the content management server (e.g., the clothing item records); (ii) provide a secure interface (e.g., a secure webpage) to permit authorized users to run reports on the collected analytics. The information collected and stored on the analytics servers is performed in accordance with the appropriate privacy laws and regulations. In one embodiment of the invention, the content stored on the analytics server may be anonymized prior to it be stored on the analytics server.

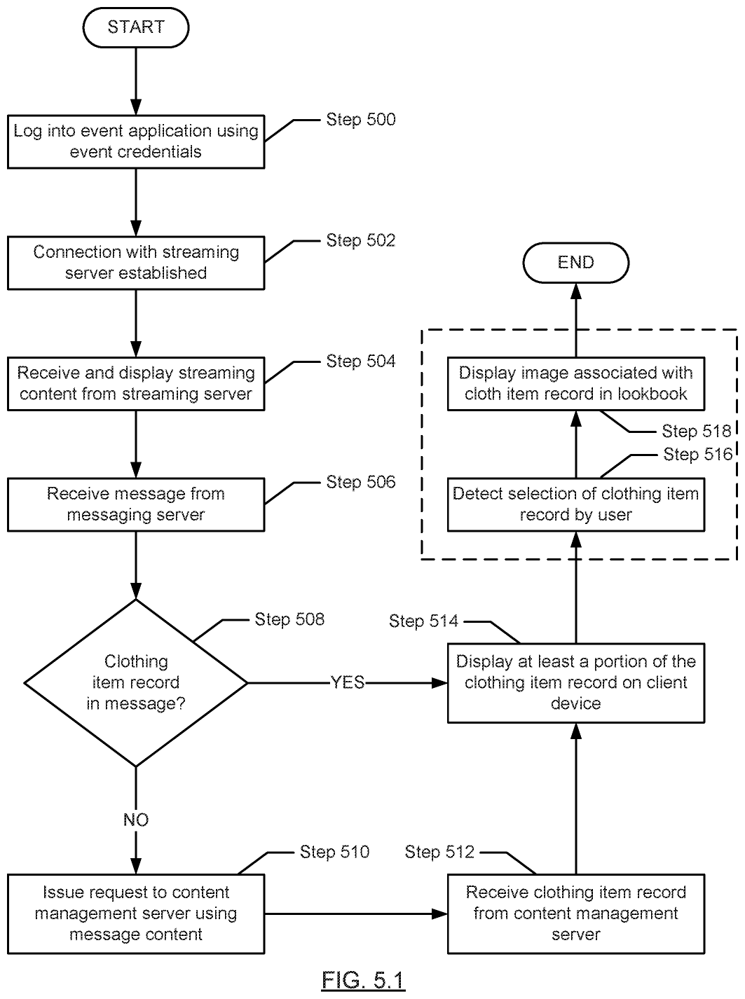

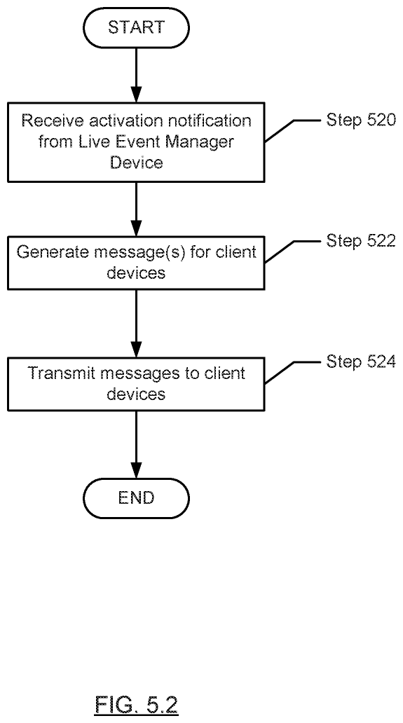

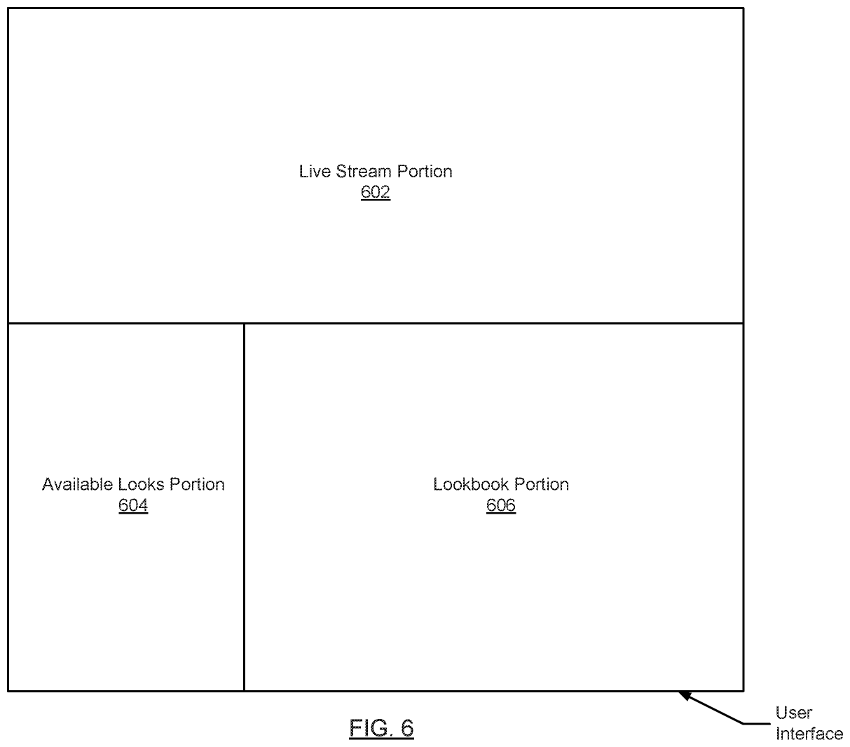

In one embodiment of the invention, each client device (210A, 201N) corresponds to any computing system (see e.g., FIG. 7) that includes functionality to: (i) concurrently display live streamed content and non-lived streamed content such as images and text (see e.g., FIG. 6), (ii) perform all or a portion of the steps shown in FIGS. 4 and 5.2. A non-limiting example of a client device is a smart phone.

As discussed above, embodiments of the invention may be used to manage content distribution during live streaming events. One such type of an event is a fashion show. FIGS. 2.1-2.3 shows various data structures, relationships between components, records that may be present in one or more embodiments of the invention when implemented for a fashion show event. Those skilled in the art will appreciate that embodiments of the invention are not limited to fashion shows.

Turning to FIG. 2.1, FIG. 2.1 shows relationships between various components for a fashion show event in accordance with one or more embodiments of the invention.

The following relationships may be created, managed, and/or modified using any type of data structure (e.g., linked lists, arrays, records, etc.), where such data structures (or portions thereof) may be located one or more of the components shown in FIG. 1. Further, the aforementioned relationships may be created, maintained, and/or modified by one or more components shown in FIG. 1.

Turning to the relationships shown in FIG. 2.1, a look (200) corresponds to the combination of one or more clothing items. For example, a look may be a dress or it may be a combination of a top (e.g., a shirt) and a bottom (e.g., pants, skirt, etc.). To this end, each look (200), which may be identified using a unique identifier, may be associated with one or more clothing item records (202). Additional detail about the clothing item records is provided in FIG. 2.2. Further, each look may be associated with an event (202). For example, an event may correspond to a particular fashion show for a particular company at a particular location, date, and time. Each look may also be associated with a model (206), e.g., the model that is going to be wearing the look in the fashion show. The model may be identified using a first and last name, a unique identifier, and/or any combination thereof. The look may also be associated with look analytics (208).

The look analytics may include information about all user interaction, via the client devices (or event applications executing on the client devices), for the look. For example, the look analytics may include, but are not limited to: (i) which users moved the look to the lookbook portion of the user interface on the event application on the client device (see e.g., FIG. 6); (ii) which users purchased the look (including what size and color they selected); (iii) which users shared the look and what communication channels they used to share the look (e.g., email, social media); (iv) whether a user used the zoom/pan (detailed view) mode for viewing the look once it is selected for the lookbook, (v) how long each user spent in zoom/pan mode for the look; (vi) how many times users used the zoom/pan mode for viewing the look; and (vii) how many users indicated that they liked (e.g., via a swipe action in a first direction) or disliked (e.g., via a swipe action in a second direction) the look.

In one embodiment of the invention, the content management system may include data structures which track all of the aforementioned information/data associated with the look (200). Alternatively, the content management system may include data structures which track all of the aforementioned information/data associated with the look (200) except the look analytics (208). In this scenario, the look analytics are stored on the analytics server.

Continuing with the discussion of FIG. 2.1, each user (210) of the system may be associated with a user profile (212). Additional detail about the user profile (212) is provided in FIG. 2.3. In addition, each user may be associated with user analytics.

The user analytics may include information about all interaction by the specific user, via the client device (or an event application executing on the client devices), for all looks. For example, the user analytics may include, but are not limited to: (i) which looks the user moved to the lookbook portion of the user interface on the event application on the client device (see e.g., FIG. 6); (ii) whether the user purchased the look (including what size and color they selected); (iii) which looks the user shared and what communication channels they used to share the looks (e.g., email, social media); (iv) whether a user used the zoom/pan (detailed view) mode for viewing the look once it is selected for the lookbook, (v) how long the user spent in zoom/pan mode for the look; (vi) how many times the user used the zoom/pan mode for viewing the look; and (vii) whether the user indicated that they liked (e.g., via a swipe action in a first direction) or disliked (e.g., via a swipe action in a second direction) the look.

In one embodiment of the invention, the content management system may include data structures which track all of the aforementioned information/data associated with the user (210). Alternatively, the content management system may include data structures which track all of the aforementioned information/data associated with the user (210) except the user analytics (214). In this scenario, the user analytics are stored on the analytics server.

In certain scenarios, the system shown in FIG. 1 may also support personal shoppers (216). In such cases, the content management system may track which personal shoppers are associated with (i.e., work with) which users. In addition, though not shown, the content management system (or another component in the system) may also maintain a user profile for the personal shopper, where the user profile tracks which looks the personal shopper selected for each its clients (represented as users within the system). In one embodiment of the invention, the analytics server may enable a personal shopper to register for updates or notifications, where such notifications may be generated based on certain criteria set by the personal shopper for a user or set of users. For example, the personal shopper may specify that when a user (i.e., one of the personal shopper's clients) spends more than 10 minutes viewing a particular look, the personal shopper is notified. The example is not intended to limit the scope of the invention.

FIG. 2.2 shows a clothing item record in accordance with one or more embodiments of the invention. Each clothing item record (220) is uniquely identified with a clothing item identifier. The clothing item record (220) may include one or more of the following components: (i) clothing description (226)—a textual description of the clothing item (e.g., name of item, material(s) in clothing, etc.); (ii) clothing media content (224)—any type of media files which illustrate all or a portion of the clothing item (e.g., pictures, videos, etc., which may only include the clothing item and/or include a model wearing the clothing item); and (iii) one or more clothing item instance entries (228A, 228N). Each of clothing item instance entries is associated particular instance of the clothing item, where each clothing item instance entry specifies <size, price, color> (230) and the number available (232) of the clothing item at the particular <size, price, color> combination. For example, if the clothing item is a pair of pants, where the designer made the pants in green and red and for each color made three pairs in each of the following sizes: size 0, 2, 4. Then in this scenario, the clothing item record would have six clothing item instance entries one for each combination of color and size.

FIG. 2.3 shows a user profile in accordance with one or more embodiments of the invention. Each user profile record (240) is uniquely identified by an identifier (242). The user profile record (240) may include one or more of the following components: (i) user name (244), which may be the user's legal name, a nickname, or any combination thereof; (ii) user contact information (246), which may include the user's email address, mailing address, billing address, phone number, etc.; and lookbook history (248). The lookbook history enables the user to see looks (and potentially other content) from past events, which the user attended (i.e., events which the user remotely attended via the event application executing on the client device). The lookbook history includes one or more lookbook instances (250A, 250B). Each lookbook instance includes: (i) event information (252), which includes information that identifies the event such as the name of the event, date of the event, the designer, etc. and (ii) the lookbook instance content (254), which includes the looks that the user selected from the event to include in their lookbook for the event.

Additionally, or alternatively, the event may correspond to a user accessing a virtual store via their client device. In this case, the event may be the name of a virtual store. In this example, the lookbook instance may include (i) store name (or another identifier) for the virtual store) and (ii) the lookbook instance content (254), which includes the looks that the user selected when they viewed content from the virtual store to include in their lookbook. In this example, the content from the virtual store may include looks that are published by the virtual store.

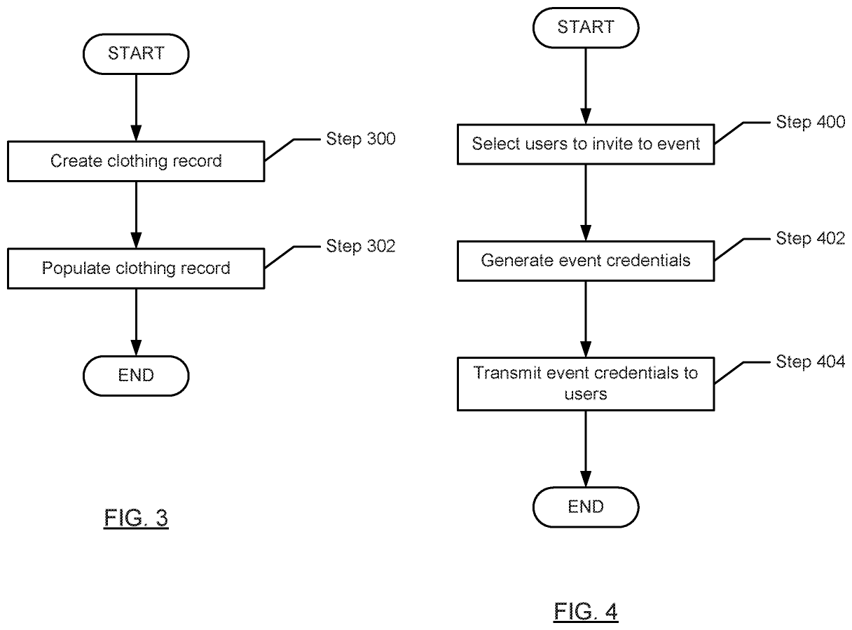

FIGS. 3-5.2 show flowcharts in accordance with one or more embodiments of the invention. While the various steps in these flowcharts are presented and described sequentially, one of ordinary skill in the art will appreciate that some or all of the steps may be executed in different orders, may be combined or omitted, and some or all of the steps may be executed in parallel. Furthermore, the steps may be performed actively or passively.

FIG. 3 shows a method for creating a clothing item record in accordance with one or more embodiments of the invention.

In step 300, a clothing item record is created. Creating the clothing item record may include instantiating a new clothing item record in the content management system.

In step 302, the clothing item record is populated. More specifically, all or portion of the content shown in FIG. 2.2 uploaded or otherwise provided to the content management system. The method shown in FIG. 3 may be performed using a secure interface (e.g., a web interface) by an authorized user.

In one embodiment of the invention, the clothing item record may be updated for time to time. For example, after a particular event, additional clothing media content (including images and/or audio-visual content) related to the clothing item record may be uploaded to content management server and then made available (via the event applications executing on the client devices) to enable the users to share the clothing media content.

FIG. 4 shows a method for inviting users to an event in accordance with one or more embodiments of the invention. In one embodiment of the invention, only users that are invited to an event (or a virtual store) may remotely attend the event via the event application executing on the computing device. FIG. 4 shows a method for generating and transmitting such an invite.

In step 400, one or more users are selected to be invited to the event (or a virtual store). The selection of the users to invite to the event may be performed using a secure interface on the content management server. Specifically, via the secure interface, an authorized user (e.g., a personal shopper, an event manager that is organizing the fashion show, etc.) may search the user profiles to identify the appropriate users to invite to the event (or a virtual store).

In step 402, event credentials are generated for each of the users to attend the event (or a virtual store). For example, a single password may be generated for all selected users or individual passwords may be generated for each of the users.

In step 404, the event credentials generated in step 402 are transmitted to clients using, e.g., the user contact information (such as via email) obtained from the user profile records.

Those skilled in the art will appreciate that other mechanisms may be used to only permit a specific set of users from remotely attending the event (or a virtual store) may be used without departing from the invention.

Once the user has been invited to attend the event (or a virtual store), the user may remotely attend the event (or visit the virtual store) using the event application executing on the client device. When the user attends the event, the user receives two types of content: (i) streaming content from the streaming server and (ii) content from clothing item records from the content management server (which may be provided directly or indirectly from the content management server). Access to the streaming content is provided once the user has successfully logged into the event application on the client device and the live stream from the event has begun. However, access to the content from the clothing item records may also be provided once a user on the event management application (executing on the live event management device) has authorized such content to the accessible to the users of the client devices. In this manner, the event management application can control which content is to be made available and when such content is to be made available. This functionality enables the user of the event management application to dynamically determine what content users may access while they are concurrently viewing a live stream.

In one embodiment of the invention, virtual store does not include any streaming content, rather, the virtual store only includes content from clothing item records from the content management server (which may be provided directly or indirectly from the content management server).

FIG. 5.1 shows a method for dynamic content distribution during a live streaming event in accordance with one or more embodiments of the invention. FIG. 5.1 is from the perspective of the client device.

Turning to FIG. 5.1, in step 500, the user (via the client devices) logs into the event application using the event credentials. The user may login to the event application using other credentials without departing from the invention.

In step 502, the event application establishes a connection with the streaming server. The event application may only establish this connection if the user of the event application has been invited to remotely attend the event.

In step 504, the event application receives and displays streaming content from the streaming server. The streaming content may be displayed in the live stream portion of the user interface of the event application (see e.g., FIG. 6, 602). Step 504 may be performed in parallel to steps 506-518. In one embodiment of the invention, the streaming content is also concurrently displayed on the event management application.

In step 506, a message is received by the event application from the messaging server. In one embodiment of the invention, the event application, prior to receiving the message, registered with the messaging server. The message may be received by the event application via a push or pull mechanism.

The message includes message content. However, the message content may vary based on one or more embodiments of the invention. In one embodiment of the invention, the message content includes all or a portion of one or more clothing item records associated with a look. In another embodiment of the invention, the message content includes a reference to all or a portion of one or more clothing item records associated with a look. In another embodiment of the invention, the one or more clothing item records (or portions thereof) associated with the look are download onto the client device prior to the event but are inaccessible to the user of the client device until the event application receives a message that includes an appropriate credential to provide access to the one or more clothing item records.

In step 508, a determination is made about whether the message content includes the one or more clothing item records (or portions thereof). If the message content includes the one or more clothing item records (or portions thereof), the process proceeds to step 514; otherwise, the process proceeds to step 510. The process may also proceed to step 514 in scenarios in which the one or more clothing item records (or portions thereof) were previously downloaded onto the client device and the message content includes credentials to permit access to this previously downloaded content.

In step 510, the event application issues a request to the content management server using the reference in the message content (e.g., a uniform resource location (URL)).

In step 512, the client device receives the requested content from the content management server.

In step 514, all or a portion of the one or more clothing item records (or portions thereof) included in the message content or obtained from the content management server (see e.g., steps 510-512) are displayed in the available looks portion of the user interface of the event application (see e.g., FIG. 6, 604). In one embodiment of the invention, only images that show the look (or portions thereof) are displayed in the available looks portion of the user interface. In such cases, the other content in the clothing items record(s) such as color, price, sizes, etc. are not displayed.

Steps 506-514 may be repeated each time the event management application issues an activation notification (see e.g., FIG. 5.2) during the event.

Steps 516-518 describe how a user may interact with the looks displayed in the available looks portion of the user interface of the event application.

Turning to step 516, in step 516, the event application may detect that the user has selected a look from the available looks portion of the user interface.

In step 518, in response to this detection, the event application may display the selected look in the lookbook portion of the user interface. Displaying the look in the lookbook portion of the user interface may include displaying one or more images of the look (or portions thereof) and also displaying available sizes, colors, price, etc. The availability shown to the user may be determined based on the geographic region in which the user is located. For example, if there are three sizes of a given dress available in the United States and two sizes of the dress available in France and the user is based on the United States, then the availability of the particular dress shown to the user is three. However, a user located in France may be shown an availability of two.

In one embodiment of the invention, the event application collects information which may be used for the user analytics (discussed above) and the look analytics (discussed above) and provides this information to the analytics server. This information may be provided to the analytics server periodically via a push or pull mechanism.

Though not shown in FIG. 5.1, in one embodiment of the invention, after a user places a look into the lookbook, the event application may enable the user to purchase the look and/or place an order for the look. In scenarios in which the user purchases the look and/or places an order for the look, the event application may connect to a 3^{rd} party payment system to facilitate such a transaction.

FIG. 5.2 shows a method for issuing activation notifications in accordance with one or more embodiments of the invention. The method shown in FIG. 5.2 is from the perspective of the messaging server.

In step 520, the messaging server receives an activation notification from the live event manager device. The activation notification may identify a particular look using, for example, a unique identifier associated with the look.

In step 522, the messaging server generates a message (as described above) for each of the client devices that are registered to receive messages for a particular event.

In step 524, the messaging server transmits the messages to the client devices (i.e., the client devices that are registered to receive messages for a particular event).

FIG. 6 shows an exemplary user interface for an event application in accordance with one or more embodiments of the invention. The invention is not limited to the user interface layout shown in FIG. 6.

The user interface (600) includes three portions: a live stream portion (602), an available looks portion (604), and a lookbook portion (606). The live stream portion displays the live stream of the event to the user. The live stream portion may include controls (not shown) to start, pause, replay, and stop the live stream.

The available looks portion (604) displays the looks that the user is permitted to view. As discussed above, the available looks portion only includes looks which have been authorized for viewing by the event management application. The specific layout of multiple looks in the available looks portion may vary based on the implementation of the invention.

The lookbook portion (606) includes any looks that the user has selected from the available looks portion. The specific layout of multiple looks in the lookbook portion may vary based on the implementation of the invention.

Instead of live streaming the event, embodiments of the invention may be implemented using pre-recorded content. In such scenarios, the user would have the same experience as-if the user was watching a live stream (see e.g., FIGS. 5.1-5.2). For example, with reference to FIG. 6, the pre-recorded content may be shown in the live stream portion (602). When this occurs, the content shown in the Available Looks Portion (604) and the Lookbook Portion (606) will correspond to the content what would have been available as-if the pre-recorded content was live streaming content.

In scenarios in which the Live Stream Portion (602) displays pre-recorded content, the pre-recorded content may be a recording of a live stream or it may be series static images. The static images may each include a model wearing a look (as defined above). The static images may be obtained from frames of a pre-recorded (or previously recorded) live stream and/or may include photographs of the model wearing the look.

In one embodiment of the invention, third parties may separately brand an instance of the event application. For example, company A may brand a first instance of the event application (A1) and company B may brand a second instance of the event application (A2). A user may subsequently obtain on their client device, a copy of A1 and A2. From the perspective of the user, A1 and A2 are two separate applications from separate companies; however, A1 and A2 may both interact with the streaming server, live event device manager, content management system, and analytics.

In some instances, the content management system and analytics server may completely segregate the content from the different companies; in other instances, the content is not completely segregated. For example, the analytics collected about the user's interaction with A1 and A2 may then be used to provide recommendations to the users and/or Company A and Company B. The recommendations may include which types of content to display to the users via A1 and A2. For example, if the user selects a looks with a certain color palette in A1, then the analytics server may provide a recommendation to A2 to show the user looks (to the extent any exist) with the same or similar color palette.

As discussed above, the look may include jewelry or other accessories. In such cases, the analytics server may track: (i) which accessories the user has selected and placed in their lookbook or (ii) which accessories that user has indicated that they are interested in based on other analytics information that has been collected by the user (as discussed above). This information may be used to make recommendations (as discussed above).

In one embodiment of the invention, the user interface of the event application may not include the Live Stream Portion (602). An example of how this scenario may be used is described below. This example is not intended to limit the scope of the invention.

Turning to the example, consider a scenario in which a live event occurs at a location, where the location includes one or more display screens, which may be mounted on the wall or on another structure such that they may be viewed by the audience of the live event. Further, one or more audience members have client devices on which an event application is executing. Further, the event applications have been given access to content for the live event as discussed above with respect to FIGS. 5.1-5.2.

With respect to the one or more display screens, the live event manager includes functionality to update the content that is shown on these display screens.

During the event, when a model walks down the run way, a number (or another identifier) corresponding to the look is shown on the one or more display screens (which may be specified by the live event manager). The same number may also be shown on the user interface (see e.g, FIG. 6), for example, in the live stream portion (602). If the number (or another identifier) is shown in the live stream portion, then either: (i) only the number is shown or (ii) the number (or another identifier) and other content (which may be a live stream) is shown in the live stream portion.

The user may then select the number (or another identifier) if the user wants to put the corresponding look in their lookbook. This may trigger only the number (or another identifier) being placed in the lookbook and/or may trigger additional content (e.g., a pre-recorded video or a photograph) being obtained from the content management server and shown, via the user interface, to the user.

Embodiments of the invention provide a mechanism for content distribution in which the content (which may be live or pre-recorded) is distributed in a manner that limits access to the content such that the access mirrors how the access would be granted as-if the user was attending a live event. This enables the company to control the manner in which its content is distributed to both live and remote participants without having to pre-release the content.

Embodiments of the technology may be implemented on a computing system. Any combination of mobile, desktop, server, embedded, or other types of hardware may be used. For example, as shown in FIG. 7, the computing system (700) may include one or more computer processor(s) (702), associated memory (704) (e.g., random access memory (RAM), cache memory, flash memory, etc.), one or more storage device(s) (706) (e.g., a hard disk, an optical drive such as a compact disk (CD) drive or digital versatile disk (DVD) drive, a flash memory stick, etc.), and numerous other elements and functionalities. The computer processor(s) (702) may be an integrated circuit for processing instructions. For example, the computer processor(s) may be one or more cores, or micro-cores of a processor. The computing system (700) may also include one or more input device(s) (710), such as a touchscreen, keyboard, mouse, microphone, touchpad, electronic pen, or any other type of input device. Further, the computing system (700) may include one or more output device(s) (708), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (700) may be connected to a network (712) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments of the technology may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the technology.

Further, one or more elements of the aforementioned computing system (700) may be located at a remote location and connected to the other elements over a network (714). Further, embodiments of the technology may be implemented on a distributed system having a plurality of nodes, where each portion of the technology may be located on a different node within the distributed system. In one embodiment of the technology, the node corresponds to a distinct computing device. Alternatively, the node may correspond to a computer processor with associated physical memory. The node may alternatively correspond to a computer processor or micro-core of a computer processor with shared memory and/or resources.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

What is claimed is:

1. A method for managing content distribution for an event, comprising:
establishing, by the streaming server, a connection with a client device;
providing, by the streaming server, streaming content for the event over the connection to the client device;
while the streaming server is providing content to the client device:
issuing a message from a messaging server to the client device, wherein the message is associated with at least a portion of the content from the streaming server;
receiving analytics information from the client device, wherein the analytics information specifies that a user of the client device interacted with one selected from group consisting of message content in the message and content referenced by the message.

2. The method of claim 1, further comprising:
prior to establishing the connection with the client device:
issuing an invitation to an event application execution on the client device; and
receiving a response to the invitation from event application, wherein receiving the response triggers the establishment of the connection.

3. The method of claim 1, further comprising:
prior to issuing the message:
generating a clothing item record;
receiving an activation notification from the live event manager device, wherein the message is issued in response to the activation notification.

4. The method of claim 3, wherein the activation notification is only valid for the clothing item record.

5. The method of claim 1, wherein the content referenced by the message comprises a clothing item record.

6. The method of claim 1, wherein the analytics information indicates that the user of the client device moved the content referenced by the message to a lookbook portion of the event application.

7. The method of claim 1, wherein the analytics information indicates that the user of the client device moved at least a portion of the message content to a lookbook portion of the event application.

8. The method of claim 1, wherein the client device is a mobile device.

9. A method for managing content distribution for an event, comprising:
establishing, by the client device, a connection with a streaming server;
receiving, by the client device, streaming content for the event over the connection;
while the client device is receiving the content:
receiving a message from a messaging server, wherein the message comprises message content which corresponds to at least a portion of the streaming content;
displaying at least the portion of the message content on the client device;
collecting, after the displaying, analytics information from the client device, wherein the analytics information specifies that the user of the client device interacted with content in the message.

10. The method of claim 9, wherein at least a portion of the streaming content corresponds to at least a portion of the message content.

11. The method of claim 9, wherein the message content comprises at least a portion of a clothing item record.

12. The method of claim 9, wherein the analytics information indicates that the user of the client device moved the content referenced by the message to a lookbook portion of a user interface of an event application executing on the client device.

13. The method of claim 9, wherein the streaming content received by the client device is displayed in a live stream portion of a user interface of an event application executing on the client device.

14. The method of claim 13, wherein at least a portion of the message content received by the client device is displayed in an available looks portion of the user interface.

15. The method of claim 9, wherein the client device is a mobile device.

16. A method for managing content distribution for an event, comprising:
establishing, by the client device, a connection with a streaming server;
receiving, by the client device, streaming content for the event over the connection;
while the client device is receiving the content:
receiving a message from a messaging server, wherein the message comprises a reference to a clothing item record for a clothing item, wherein the clothing item is included in to at least a portion of the streaming content;
issuing a request to content management server (CMS) for the clothing item record using the reference;
receiving the clothing item record from the CMS;
displaying at least the portion of the clothing item record on the client device;
collecting, after the displaying, analytics information from the client device, wherein the analytics information specifies that the user of the client device interacted with at least a portion of the clothing item record.

17. The method of claim 16, wherein the analytics information indicates that the user of the client device moved the content referenced by the message to a lookbook portion of a user interface of an event application executing on the client device.

18. The method of claim 16, wherein the streaming content received by the client device is displayed in a live stream portion of a user interface of an event application executing on the client device.

19. The method of claim 18, wherein at least a portion of the message content received by the client device is displayed in an available looks portion of the user interface.

20. The method of claim 16, wherein the client device is a mobile device.

21. A non-transitory computer readable medium comprising computer readable program code, which when executed by a computer processor enables the computer processor to perform a method for servicing requests, the method comprising:
establishing, by the streaming server, a connection with a client device;
providing, by the streaming server, streaming content for an event over the connection to the client device;
while the streaming server is providing content to the client device:
issuing a message from a messaging server to the client device, wherein the message is associated with at least a portion of the content from the streaming server;
receiving analytics information from the client device, wherein the analytics information specifies that a user of the client device interacted with one selected from group consisting of message content in the message and content referenced by the message.

22. A non-transitory computer readable medium comprising computer readable program code, which when executed by a computer processor enables the computer processor to perform a method for servicing requests, the method comprising:
establishing, by the client device, a connection with a streaming server;
receiving, by the client device, streaming content for the event over the connection;
while the client device is receiving the content:
receiving a message from a messaging server, wherein the message comprises message content which corresponds to at least a portion of the streaming content;
displaying at least the portion of the message content on the client device;
collecting, after the displaying, analytics information from the client device, wherein the analytics information specifies that the user of the client device interacted with content in the message.

23. A non-transitory computer readable medium comprising computer readable program code, which when executed by a computer processor enables the computer processor to perform a method for servicing requests, the method comprising:
establishing, by the client device, a connection with a streaming server;
receiving, by the client device, streaming content for the event over the connection;
while the client device is receiving the content:
receiving a message from a messaging server, wherein the message comprises a reference to a clothing item record for a clothing item, wherein the clothing item is included in to at least a portion of the streaming content;
issuing a request to content management server (CMS) for the clothing item record using the reference;
receiving the clothing item record from the CMS;
displaying at least the portion of the clothing item record on the client device;
collecting, after the displaying, analytics information from the client device, wherein the analytics information specifies that the user of the client device interacted with at least a portion of the clothing item record.
